(19) United States
(12) Patent Application Publication
(10) Pub. No.: US 2025/0177233 A1
(43) Pub. Date: Jun. 5, 2025

(54) SYSTEM AND METHOD FOR SIMULTANEOUSLY PROVIDING ALTERNATING LOW PRESSURE THERAPY AND SKIN COOLING

(71) Applicant: Hill-Rom Services, Inc., Batesville, IN (US)

(72) Inventors: Jnanesha Ramegowda, Batesville, IN (US); Darrell L. Borgman, Batesville, IN (US); Olivia Gubitose Boyce, Cincinnati, OH (US)

(21) Appl. No.: 18/959,875

(22) Filed: Nov. 26, 2024

Related U.S. Application Data
(60) Provisional application No. 63/604,238, filed on Nov. 30, 2023.

(51) Int. Cl. A61H 9/00

(52) U.S. Cl. CPC A61H 9/0078; A61H 9/0071; A61H 2201/0103; A61H 2201/1238; A61H 2201/1654; A61H 2201/168; A61H 2201/5007; A61H 2201/5053

(57) ABSTRACT

A system and method for providing a continuous flow of air to the skin of a patient supported on a patient support surface while also providing either continuous low pressure support or alternating low pressure therapy.

### PRIORITY CLAIM

This application claims priority under 35 U.S.C. § 119 (e) to U.S. Provisional Application No. 63/604,238, filed Nov. 30, 2023, which is expressly incorporated by reference herein in its entirety.

### BACKGROUND

The present disclosure is directed to a patient therapy system that provides a continuous flow of air to cool and dry the skin of an occupant of a patient support surface while also providing either alternating or continuous low pressure therapy to the patient.

The use of air bladders to support a patient to provide a low pressure interface is well known. It is also known in the art to alternate the pressure in bladders to vary the pressure exerted on a patient to thereby reduce the potential for pressure ulcers, also known as bed sores, to develop on the patient's skin. It has also been found that providing a flow of air through a coverlet to remove moisture that develops at the interface of a patient and the cover of a mattress further reduces the potential for the development of pressure ulcers. These therapies generally require one or more air sources to control the pressurization of the air in the air bladders and a different air source to provide the flow of air through the coverlet. The use of multiple air sources and the associated plumbing requires structures that add expense to the support surface or mattress being used.

### SUMMARY

The present disclosure includes one or more of the features recited in the appended claims and/or the following features which, alone or in any combination, may comprise patentable subject matter.

According to a first aspect of the present disclosure, a patient therapy management system comprises a support surface and a pneumatic system. The support surface has a plurality of bladders. At least some of the bladders comprise openings in an upper surface to allow air to escape the bladder when the bladder is pressurized. The support surface also has an air distribution layer positioned on the plurality of bladders, the air distribution layer distributing the air that escapes from the bladders to provide moisture management to a patient supported on the support surface by removing moisture from the support surface. The pneumatic system provides a flow of pressurized air to the bladders. The pneumatic system has a first mode in which all of the bladders are inflated sufficiently to provide continuous low pressure therapy to the patient and a second mode in which groups of bladders are alternately inflated to provide alternating low pressure therapy to the patient. The pneumatic system provides a sufficient flow of air to provide moisture management to the patient in both the first and second modes.

In some embodiments of the first aspect, the number of openings in the at least some bladders comprising openings varies depending on the position of the respective bladder in the support surface.

In some embodiments of the first aspect, the size of the openings in the at least some bladders comprising openings varies depending on the position of the opening on the respective bladder.

In some embodiments of the first aspect, the size of the openings in the at least some bladders comprising openings varies depending on the position of the respective bladder in the support surface.

In some embodiments of the first aspect, the air distribution layer comprises a three-dimensional material.

In some embodiments of the first aspect, the support surface comprises an upper layer having a breathable material permitting air to escape the surface and impinge upon a patient supported on the upper layer.

In some embodiments of the first aspect, the bladders comprise a first group fluidly interconnected and a second group fluidly interconnected, the first and second groups each connected to a respective valve of the pneumatic system, the valves being controlled to operate between the first and second modes to control the inflation cycles of the respective first and second groups.

In some embodiments of the first aspect, the pneumatic system comprises a variable flow air source that is operated at different flow rates based on the mode of operation to thereby control the flow air into the air distribution layer.

According to a second aspect of the present disclosure, a patient support surface comprises a mattress and a pneumatic system. The mattress has a flexible upper cover and a distribution layer supporting the flexible upper cover. The distribution layer permits air to flow throughout the distribution layer to exhaust from the patient support surface. The mattress has an inflatable layer comprising a plurality of inflatable cells, the inflatable cells being separated into a plurality of groups. Each of the inflatable cells of each one of the plurality of groups is interconnected by a manifold to provide fluid communication between the inflatable cells of the group. Each of the inflatable cells has an exhaust that is in fluid communication with the distribution layer. The pneumatic system has an air source providing a flow of pressurized air and a plurality of valves with each valve having an inlet coupled to the air source and an outlet. Each outlet is connected to a respective manifold of one of the groups of inflatable cells. Each valve selectively controls the flow of pressurized air from the air source to the respective manifold to provide a therapeutic treatment to a person supported on the patient support apparatus.

In some embodiments of the second aspect, the patient support surface further comprises a controller having a processor and a memory device, the memory device including instructions that when executed by the processor, cause the controller to vary the operation of the air source to change the flow of pressurized air from the air source.

In some embodiments of the second aspect, the memory device includes instructions that when executed by the processor, cause the controller to alternately close one of the plurality of valves to thereby stop the flow of air to the group of air cells coupled to the valve that is closed, the air cells deflating due to the exhaust in the air cells.

In some embodiments of the second aspect, the memory device includes instructions that when executed by the processor, cause the controller to alternately open the closed valve and to close a different one of the plurality of valves to thereby stop the flow of air to the group of air cells coupled to the valve that is closed and the pressure in the air cells is lowered due to the air exiting the exhaust in the air cells; the previously deflated air cells thereby being inflated.

In some embodiments of the second aspect, the memory device includes instructions that when executed by the processor, cause the controller to alternately and intermittently close and open the plurality of valves to thereby stop the flow of air to the group of air cells coupled to the valve that is closed and the pressure in the air cells is lowered due to the air exiting the exhaust in the air cells, and inflate any previously deflated air cells to provide alternating low pressure therapy to a patient supported on the patient support apparatus.

In some embodiments of the second aspect, the memory device includes instructions that when executed by the processor, cause the controller to vary the operation of the air source to change the volume of the flow of pressurized air from the air source to compensate for the respective state of the plurality of valves to maintain a predetermined level of inflation in the air cells receiving the flow of air.

In some embodiments of the second aspect, the patient support surface further comprises a controller having a processor and a memory device, the memory device including instructions that when executed by the processor, cause the controller to vary the operation of the pneumatic system to operate in a first mode where the groups of bladders are inflated to a continuous pressure to provide continuous low pressure therapy to a patient supported on the patient support apparatus and a second mode where the groups of bladders are alternately and intermittently inflated to provide an alternating low pressure therapy to the patient, the pneumatic system being operated to provide a flow of air sufficient to remove moisture from the mattress in both the first and second modes.

In some embodiments of the second aspect, the memory device includes instructions that when executed by the processor, cause the controller to vary the operation of the air source to change the volume of the flow of pressurized air from the air source to compensate for the respective state of the plurality of valves to maintain a predetermined level of inflation in the air cells receiving the flow of air.

In some embodiments of the second aspect, the memory device includes instructions that when executed by the processor, cause the controller to vary the operation of the air source to change the pressure of the flow of pressurized air from the air source to compensate for the respective state of the plurality of valves to maintain a predetermined level of inflation in the air cells receiving the flow of air.

In some embodiments of the second aspect, the memory device includes instructions that when executed by the processor, cause the controller to vary the operation of the air source to change the pressure of the flow of pressurized air from the air source to compensate for the respective state of the plurality of valves to maintain a predetermined level of inflation in the air cells receiving the flow of air.

According to a third aspect of the present disclosure, a method of providing therapy to a patient supported on a surface having a plurality of groups of bladders, at least some of the bladders having outlets configured to allow pressurized air to escape from the respective bladder and enter into an air distribution layer comprises providing a flow of air into the groups of bladders sufficient to maintain a lower pressure interface for the patient supported on the air distribution layer, and intermittently stopping the flow of air into a first one of the groups of bladders to allow the first group of bladders to deflate through the outlets of at least some of the bladders in the first group.

In some embodiments of the third aspect, the method includes alternately and intermittently stopping the flow of air into a second one of the groups of bladders to allow the second group of bladders to deflate through the outlets in the at least some of the bladders in the second group.

In some embodiments of the third aspect, the step of stopping the flow of air into the second one of the groups occurs after the flow of air to the first group of bladders has been re-established and sufficient time as elapsed for the first group of bladders to reach an inflation state that provides a low pressure interface sufficient to support the patient.

In some embodiments of the third aspect, the method further includes changing the operation of a source of pressurized air to vary the volume of flow from the source of pressurized air to provide sufficient flow to compensate for the changes in flow to the respective groups of bladders.

According to a fourth aspect of the present disclosure, a patient therapy management system comprises a support surface and a pneumatic system. The support surface has a plurality of bladders. At least some of the bladders comprise openings in an upper surface to allow air to escape the bladder when the bladder is pressurized. The support surface also comprises an air distribution layer positioned on the plurality of bladders, the air distribution layer distributing the air that escapes from the bladders to provide moisture management to a patient supported on the support surface by removing moisture from the support surface. The pneumatic system provides a flow of pressurized air to the bladders, the pneumatic system having at least one therapy mode in which at least some of the bladders are inflated sufficiently to therapy to the patient the pneumatic system providing a sufficient flow of air to provide moisture management to the patient during therapy modes.

In some embodiments of the fourth aspect, the number of openings in the at least some bladders comprising openings varies depending on the position of the respective bladder in the support surface.

In some embodiments of the fourth aspect, the size of the openings in the at least some bladders comprising openings varies depending on the position of the opening on the respective bladder.

In some embodiments of the fourth aspect, the size of the openings in the at least some bladders comprising openings varies depending on the position of the respective bladder in the support surface.

In some embodiments of the fourth aspect, the air distribution layer comprises a three-dimensional material.

In some embodiments of the fourth aspect, the support surface comprises an upper layer having a breathable material permitting air to escape the surface and impinge upon a patient supported on the upper layer.

In some embodiments of the fourth aspect, the bladders comprise a first group fluidly interconnected and a second group fluidly interconnected, the first and second groups each connected to a respective valve of the pneumatic system, the valves being controlled to operate between the first and second modes to control the inflation cycles of the respective first and second groups.

In some embodiments of the fourth aspect, the pneumatic system comprises a variable flow air source that is operated at different flow rates based on the mode of operation to thereby control the flow air into the air distribution layer.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a perspective view of a patient support apparatus of the present disclosure, the patient support apparatus embodied as a hospital bed having a therapy management system, the therapy management system including a patient support surface embodied as a pneumatic mattress and a pneumatic system coupled to the pneumatic mattress;

FIG. 2 is a diagrammatic representation of a portion of the control system of the patient support apparatus of FIG. 1 according to the present disclosure;

FIG. 3 is a diagrammatic representation of the therapy management system of the patient support of FIG. 1, FIG. 3 showing a diagrammatic representation of the pneumatic system coupled to a diagrammatic cross-sectional representation of the mattress; and

FIG. 4 is a top view of a group of bladders forming a core of the mattress of FIG. 3, the bladders shown to include through-holes that allow air to escape from the bladders and move into an air distribution structure of the mattress.

### DETAILED DESCRIPTION

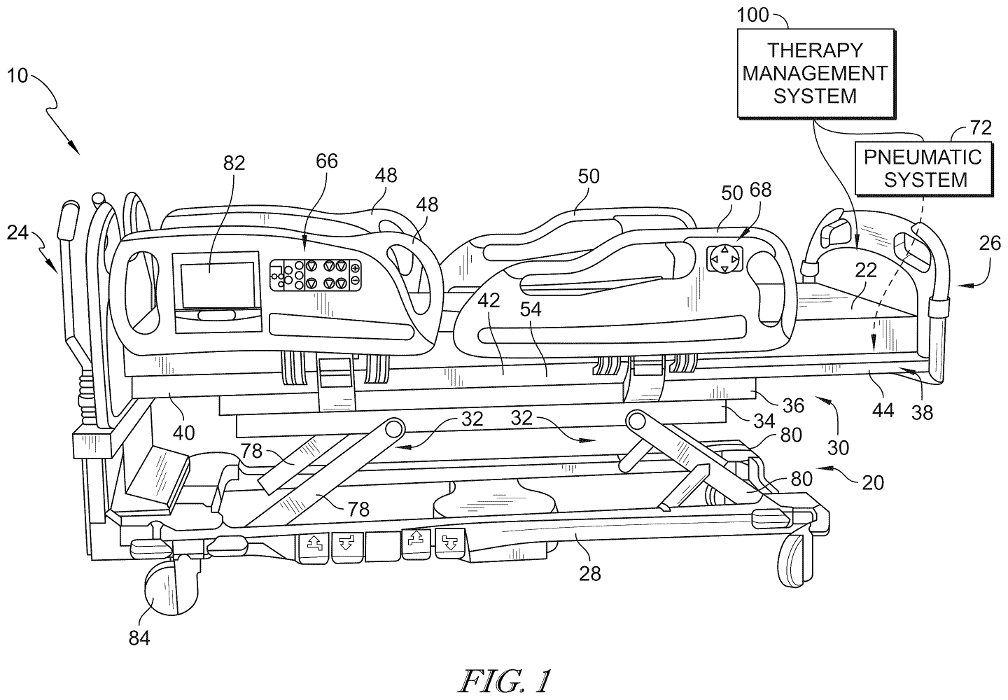

According to the present disclosure, the cost of delivering both alternating low pressure therapy and moisture management therapy is reduced. According to the present disclosure, one of the two air sources is eliminated and a single air source is used to provide both therapies. Additionally, the airflow for moisture management is directed upwards towards the patient. This allows for a low profile, minimal-thickness spacer material to be used to control the flow of air for moisture management. According to the present disclosure, this is accomplished with a patient support apparatus, such as illustrative hospital bed 10 that includes a patient support structure such as a frame 20 that supports a surface or mattress 22 as shown in FIG. 1. Thus, according to this disclosure a bed frame, a mattress or both are examples of structures considered to be within the scope of the term “patient support structure.” However, this disclosure is applicable to other types of patient support apparatuses and other patient support structures, including other types of beds, surgical tables, examination tables, stretchers, and the like.

As will be described further herein, the bed 10 includes a therapy management system 100 for providing therapy to the patient by influencing the moisture at the interface of a patient's skin with the surface 22 and providing alternating low pressure therapy. The present disclosure provides a method and structure for mitigating the cost of providing moisture management and alternating low pressure therapy to a person supported on the surface 22 by combining structures and operations. It is contemplated by this disclosure that the therapy management system 100 disclosed herein may be operated automatically based on preprogrammed routines or manually based on user input commands received from a graphical display screen 82 (See FIG. 1) providing a graphic user interface.

Referring again to FIG. 1, the frame 20 of the bed 10 includes a base 28, an upper frame assembly 30 and a lift system 32 coupling upper frame assembly 30 to base 28. The lift system 32 is operable to raise, lower, and tilt the upper frame assembly 30 relative to the base 28. The bed 10 has a head end 24 and a foot end 26. The base 28 includes wheels or casters 84 that roll along a floor as the bed 10 is moved from one location to another.

The hospital bed 10 has four siderail assemblies coupled to upper frame assembly 30 as shown in FIG. 1. The four siderail assemblies include a pair of head siderail assemblies 48 (sometimes referred to as head rails) and a pair of foot siderail assemblies 50 (sometimes referred to as foot rails). Each of the siderail assemblies 48, 50 is movable between a raised position, as shown in FIG. 1, and a lowered position (not shown). The siderail assemblies 48, 50 are sometimes referred to herein as siderails 48, 50.

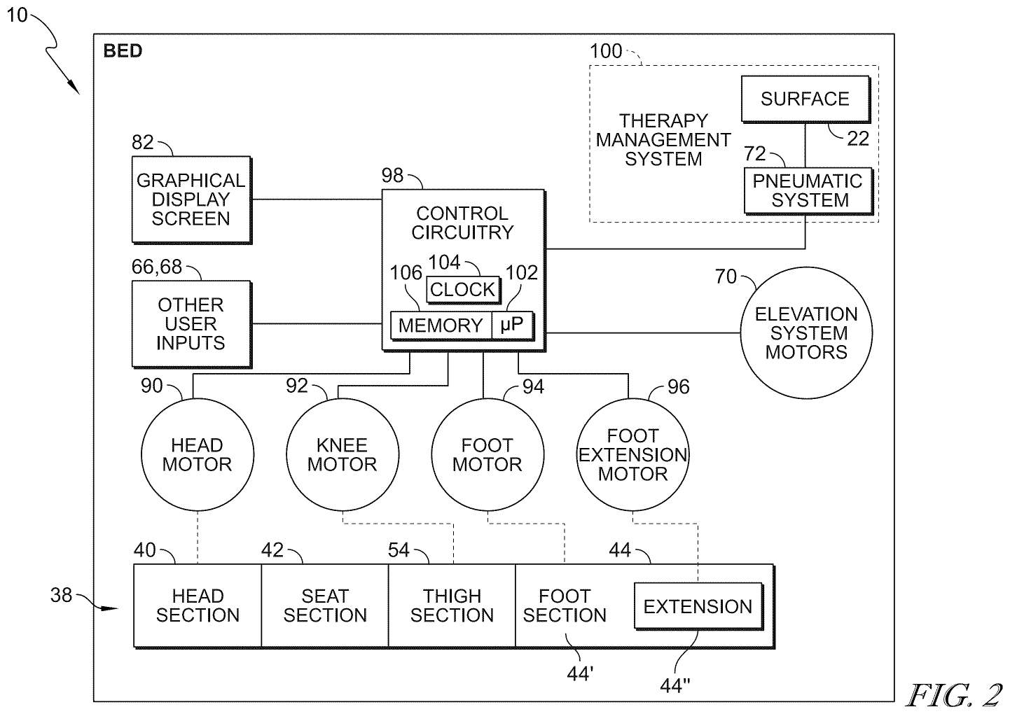

The upper frame assembly 30 includes a lift frame 34, a weigh frame 36 supported with respect to lift frame 34, and a patient support deck 38. The patient support deck 38 is carried by the weigh frame 36 and engages a bottom surface of the mattress 22. The patient support deck 38 includes a head section 40, a seat section 42, a thigh section 54 and a foot section 44 in the illustrative example as shown in FIG. 1 and as shown diagrammatically in FIG. 2. The sections 40, 54, 44 are each movable relative to weigh frame 36. For example, the head section 40 pivotably raises and lowers relative to the seat section 42 whereas the foot section 44 pivotably raises and lowers relative to the thigh section 54. Additionally, the thigh section 54 articulates relative to the seat section 42. Also, in some embodiments, the foot section 44 is extendable and retractable to change the overall length of the foot section 44 and therefore, to change the overall length of the deck 38. For example, the foot section 44 includes a main portion 44′ and an extension 44″ in some embodiments as shown diagrammatically in FIG. 2.

As shown diagrammatically in FIG. 2, the bed 10 includes a head motor or actuator 90 coupled to the head section 40, a knee motor or actuator 92 coupled to the thigh section 54, a foot motor or actuator 94 coupled to the foot section 44, and a foot extension motor or actuator 96 coupled to the foot extension 44″. The motors 90, 92, 94, 96 may include, for example, an electric motor of a linear actuator. In those embodiments in which seat section 42 translates along upper frame 30 as mentioned above, a seat motor or actuator (not shown) is also provided. The head motor 90 is operable to raise and lower the head section 40, the knee motor 92 is operable to articulate the thigh section 54 relative to the seat section 42, the foot motor 94 is operable to raise and lower the foot section 44 relative to the thigh section 54, and foot extension motor 96 is operable to extend and retract an extension 44″ of foot section 44 relative to main portion 44′ of foot section 44.

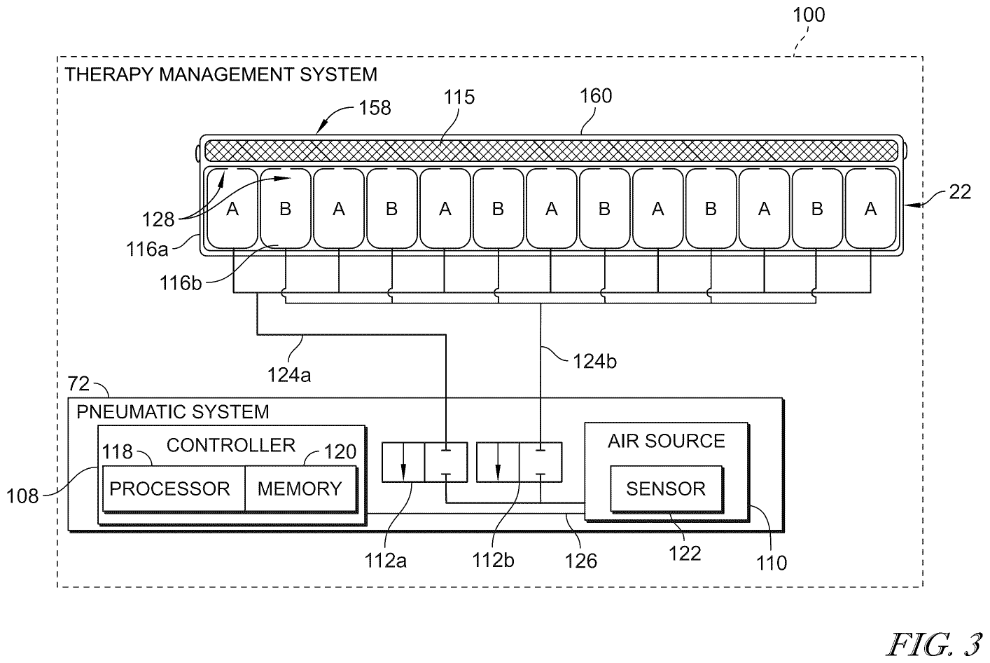

The bed 10 includes a pneumatic system 72 that controls inflation and deflation of various one or more bladders 116a, 116b of mattress 22 (see FIG. 3) and provides air for operation of the therapy management system 100 as described herein. The pneumatic system 72 is represented in FIG. 2 as a single block but that block 72 is intended to represent one or more air sources (e.g., a fan, a blower, a compressor) and associated valves, manifolds, air passages, air lines or tubes, pressure sensors, and the like, as well as the associated electric circuitry, that are typically included in a pneumatic system for inflating and deflating air bladders of mattresses of hospital beds and for operating therapy management systems as will be described in further detail below. In other embodiments, separate pneumatic systems may be provided for air bladders in a core of a mattress and for the therapy management system of a mattress described herein. In other embodiments, the mattress may comprise a foam core and the bladders 116a, 116b may be reduced in size to limit the volume of air required to support a patient.

As also shown diagrammatically in FIG. 2, lift system 32 of bed 10 includes one or more elevation system motors or actuators 70, which in some embodiments, comprise linear actuators with electric motors. Thus, actuators 70 are sometimes referred to herein as motors 70. Alternative actuators or motors contemplated by this disclosure include hydraulic cylinders and pneumatic cylinders, for example. The motors 70 of lift system 32 are operable to raise, lower, and tilt upper frame assembly 30 relative to base 28. In the illustrative embodiment, one of motors 70 is coupled to, and acts upon, a set of head end lift arms 78 and another of motors 70 is coupled to, and acts upon, a set of foot end lift arms 80 to accomplish the raising, lowering and tilting functions of upper frame 30 relative to base 28.

Each siderail 48 includes a first user control panel 66 and each siderail 50 includes a second user control panel 68. The controls panels 66, 68 include various buttons that are used by a caregiver (not shown) to control associated functions of the bed 10. For example, the control panel 66 includes buttons that are used to operate the head motor 90 to raise and lower the head section 40, buttons that are used to operate the knee motor to raise and lower the thigh section 54, and buttons that are used to operate the motors 70 to raise, lower, and tilt the upper frame assembly 30 relative to the base 28. In the illustrative embodiment, the control panel 68 includes buttons that are used to operate the motor 94 to raise and lower the foot section 44 and buttons that are used to operate the motor 96 to extend and retract the foot extension 44″ relative to the main portion 44′. In some embodiments, the buttons of control panels 66, 68 comprise membrane switches.

As shown diagrammatically in FIG. 2, bed 10 includes control circuitry 98 that is electrically coupled to motors 90, 92, 94, 96 and to motors 70 of lift system 32. Control circuitry 98 is represented diagrammatically as a single block 98 in FIG. 6, but control circuitry 98 in some embodiments comprises various circuit boards, electronics modules, and the like that are electrically and communicatively interconnected. Control circuitry 98 includes one or more microprocessors 102 or microcontrollers that execute software to perform the various control functions and algorithms described herein and a clock 104 for providing date and time information to the microprocessors 102. The circuitry 98 also includes memory 106 for storing software, variables, calculated values, and the like as is well known in the art. The pneumatic system 72 has a separate controller 108 as discussed below. The control circuitry 98 may communicate with the controller 108 to share information between the control circuitry 98 and controller 108 to optimize the operation of the therapy management system 100.

As also shown diagrammatically in FIG. 2, a user inputs block represents the various user inputs such as buttons of control panels 66, 68 for example, that are used by the caregiver or patient to communicate input signals to control circuitry 98 of bed 10 to command the operation of the various motors 70, 90, 92, 94, 96 of bed 10, as well as commanding the operation of other functions of bed 10. Bed 10 includes at least one graphical user input or display screen 82 coupled to a respective siderail 48 as shown in FIG. 1. Display screen 82 is coupled to control circuitry 98 as shown diagrammatically in FIG. 2. In some embodiments, two graphical user interfaces 82 are provided and are coupled to respective siderails 48. Thus, it is contemplated by this disclosure that a graphical user interface 82 may be coupled to any of barriers 48, 50 of bed 10. Alternatively or additionally, graphical user interface 82 is provided on a hand-held device such as a pod or pendant that communicates via a wired or wireless connection with control circuitry 98.

Control circuitry 98 receives user input commands from graphical display screen 82 when display screen 82 is activated. The user input commands control various functions of bed 10 such as controlling the pneumatic system 72 and therefore, the surface functions of surface 22. In some embodiments, the input commands entered on user interface 82 also control the functions of one or more of motors 70, 90, 92, 94, 96 but this need not be the case. In some embodiments, input commands entered on the user interface 82 also control functions of a scale system.

According to one embodiment, the surface 22 and the pneumatic system 72 cooperate to provide the therapy management system 100 for influencing the temperature and moisture at the interface of the surface 22 and a patient as suggested diagrammatically in FIGS. 2 and 3. As shown diagrammatically in FIG. 3, the pneumatic system 72 includes an air source 110 embodied as a variable speed low pressure blower that operates to pressurize a portion of the therapy management system 100 as discussed below. The pneumatic system 72 also includes and a first valve 112a and a second valve 112b, the valves 112a and 112b operable to control the flow path for the air from the air mover 110 to the bladders 116a and 116b, and ultimately to an air distribution structure 115 to thereby provide an air flow that impinges onto the skin of a patient supported on the air distribution structure 115.

The controller 108 includes a processor 118 and a memory device 120. The memory device 120 includes instructions that, when processed by the processor 118, cause the controller 108 to control operation of the components of the pneumatic system 72. The controller 108 is operable to receive signals from a sensor 122 associated with the air mover 110. The sensor 122 provides the controller 108 signals that are indicative of the operation of the air mover 110. The sensor 122 is illustratively a pressure sensor that provides a signal indicative of the pressure associated with the air mover 110 which is indicative of the flow through the air mover 110. In other embodiments, the sensor 122 may be a flow meter, a tachometer, a current sensor, or other sensor that is indicative of the operation of the air mover 110 and the flow through the therapy management system 100 based on the operation of the air mover 110.

The controller 108 is operable to control the air mover 110 based on the signals from the sensor 122. The instructions in the memory device 120 include a closed-loop control algorithm that relies on the sensor 122 to determine the operation of the air mover 110 to control the flow through the therapy management system 100. For example, the variable speed blower 110 is coupled to a conduit 126 that is, in turn, coupled to inlet ports of the valves 112a, 112b. The air generated by the blower 110 is conducted through the conduit 126 and the ultimate path for the flow of the air is controlled by the valves 112a, 112b. The valve 112a has an outlet that connects to a manifold 124a which is connected to each of the bladders 116a. Please note that the bladders designated as “A” bladders in FIG. 3 are all interconnected through the manifold 124a to the valve 112a and air freely moves between each of the bladders 116a through the manifold 124a. Similarly, the valve 112b has an outlet that connects to a manifold 124b which is connected to each of the bladders 116b. Please note that the bladders designated as “B” bladders in FIG. 3 are all interconnected through the manifold 124b to the valve 112b and air freely moves between each of the bladders 116b through the manifold 124b. Each of the bladders 116a, 116b are shown in FIG. 3 to include an opening 128 in FIG. 3. The arrangement of the openings will be discussed in further detail below, but the concept of the present disclosure can be understood to have openings in the bladders 116a, 116b that allows air that flows to the bladders 116a, 116b to be continually exhausted into the air distribution structure 115 which includes a spacer material that allows air to flow through the spacer material and tends to cool and dry the skin of a patient supported on an upper surface 158 of the surface 22.

In one illustrative embodiment, air distribution structure 115 includes a three-dimensional material such as fiber network formed of a woven, knitted, or non-woven spacer fabric which is soft and flexible and/or comprises thermoplastic fibers or monofilaments. In general, the spacer fabric is stretchable in at least two directions. In other embodiments, the three-dimensional material includes a plurality of resilient or compressible projections and depressions. The air distribution structure 115 may include multiple layers. In one illustrative embodiment, an upper cover 160 includes a breathable material such as nylon. In other embodiments, cover 160 is formed from an air permeable material. The combination of the cover 160 and the air distribution structure 115 allows air to flow from the bladders 116a, 116b to provide cooling of the patient's skin as well as a flow of air to help conduct moisture away from the cover 160, thereby drying the patient's skin.

While the concepts of moisture management such as that described above are known, in the embodiment of FIG. 3, the bladders 116a, 116b are also configured to selectively provide alternating low pressure therapy to a patient. The therapy management system 100 can be operated in a first mode where the valves 112a, 112b are in a continuously open condition which allows air from the air source 110 to flow through the valves 112a, 112b into the manifolds 124a, 124b, and through the bladders 116a, 116b. In this way the patient is continuously supported on all of the bladders 116a, 116b and provided both a low interface pressure continuous support and moisture management therapy.

In another mode, the valves 112a, 112b are operated in an alternating pressure cycle that involves closing one of the valves 112a, 112b for a period of time such that the air in the system downstream the valve is allowed to exhaust through the respective bladders 116a or 116b so that the “A” group or “B” group of deflates and the patient is supported on the other of the “A” group or “B” group. By cycling between the “A” group and “B” group intermittently, the patient is subjected to the therapeutic benefits of a gentle, alternating low pressure. Alternating low pressure is known in the art to reduce the incidence of bed sores, also known as pressure ulcers, because portions of the patients skin are unloaded on a regular basis, thereby reducing the stress and shear on the patient's skin.

Utilizing the signals from the sensor 122, the controller 108 is operable to vary the speed of the air mover 110 to control the rate of the volume flow into the conduit 126 which then allows the flow of air to be varied depending on the mode of operation of the therapy management system 100 so that a sufficient flow is moved by the air mover 110 to achieve the particular therapy. In some situations, the air mover 10 may have a variable pressure output and the controller 108 varies the pressure output by the air mover 110. In some situations, the flow of air is varied depending on the state of the valves 112a, 112b. It is also contemplated that, if necessary, the air mover 110 could be reversed to cause air to be evacuated from the bladders 116a, 116b under certain conditions.

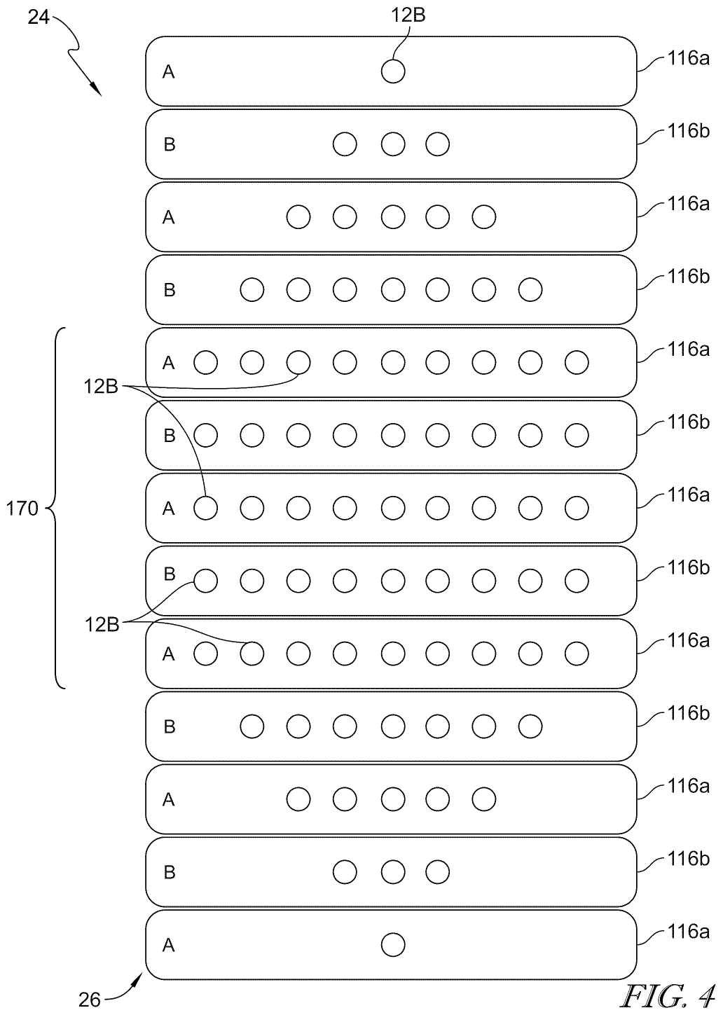

Referring now to FIG. 4, a diagrammatic top view of the bladders 116a, 116b illustrates how openings 128 may be distributed over the array of bladders 116a, 116b that extend from the head end 24 to the foot end 26. A region 170 is located where the patient's torso and seat would be located on the surface 22. Having more openings 128 in the region 170 helps control the location of the flow of air into the structure 115, thereby directing the air to the locations where it is needed most. It should be understood that the openings 128 may be positioned and sized in various configurations to provide the appropriate flow of air to the air distribution layer 115. In some embodiments, the controller 108 may be tuned to operate the air mover 110 based on the configuration of openings 128.

Although this disclosure refers to specific embodiments, it will be understood by those skilled in the art that various changes in form and detail may be made without departing from the subject matter set forth in the accompanying claims. For example, while the disclosure has been illustrated and described in detail in the drawings and the foregoing description, such illustration and description are to be considered illustrative or exemplary and not restrictive. The disclosure is not limited to the disclosed embodiments. From reading the present disclosure, other modifications will be apparent to a person skilled in the art. Such modifications may involve other features, which are already known in the art and may be used instead of or in addition to features already described herein. In the claims, the word “comprising” does not exclude other elements or steps, and the indefinite article “a” or “an” does not exclude a plurality.

1. A patient therapy management system comprising:
a support surface having a plurality of bladders, at least some of the bladders comprising openings in an upper surface to allow air to escape the bladder when the bladder is pressurized, and an air distribution layer positioned on the plurality of bladders, the air distribution layer distributing the air that escapes from the bladders to provide moisture management to a patient supported on the support surface by removing moisture from the support surface; and
a pneumatic system providing a flow of pressurized air to the bladders, the pneumatic system having a first mode in which all of the bladders are inflated sufficiently to provide continuous low pressure therapy to the patient and a second mode in which groups of bladders are alternately inflated to provide alternating low pressure therapy to the patient, the pneumatic system providing a sufficient flow of air to provide moisture management to the patient in both the first and second modes.

2. The patient therapy system of claim 1, wherein the number of openings in the at least some bladders comprising openings varies depending on the position of the respective bladder in the support surface.

3. The patient therapy system of claim 2, wherein the size of the openings in the at least some bladders comprising openings varies depending on the position of the opening on the respective bladder.

4. The patient therapy system of claim 1, wherein the size of the openings in the at least some bladders comprising openings varies depending on the position of the opening on the respective bladder.

5. The patient therapy system of claim 1, wherein the size of the openings in the at least some bladders comprising openings varies depending on the position of the respective bladder in the support surface.

6. The patient therapy system of claim 1, wherein the air distribution layer comprises a three-dimensional material.

7. The patient therapy system of claim 1, wherein the support surface comprises an upper layer having a breathable material permitting air to escape the surface and impinge upon a patient supported on the upper layer.

8. The patient therapy system of claim 1, wherein the bladders comprise a first group fluidly interconnected and a second group fluidly interconnected, the first and second groups each connected to a respective valve of the pneumatic system, the valves being controlled to operate between the first and second modes to control the inflation cycles of the respective first and second groups.

9. The patient therapy system of claim 8, wherein the pneumatic system comprises a variable flow air source that is operated at different flow rates based on the mode of operation to thereby control the flow air into the air distribution layer.

10. The patient therapy system of claim 1, wherein the pneumatic system comprises a variable flow air source that is operated at different flow rates based on the mode of operation to thereby control the flow air into the air distribution layer.

11. A patient support surface comprising:
a mattress having a flexible upper cover, a distribution layer supporting the flexible upper cover, the distribution layer permitting air to flow throughout the distribution layer to exhaust from the patient support surface, and an inflatable layer comprising a plurality of inflatable cells, the inflatable cells being separated into a plurality of groups, each of the inflatable cells of each one of the plurality of groups being interconnected by a manifold to provide fluid communication between the inflatable cells of the group, each of the inflatable cells having an exhaust that is in fluid communication with the distribution layer; and
a pneumatic system having an air source providing a flow of pressurized air, a plurality of valves with each valve having an inlet coupled to the air source and an outlet, each outlet connected to a respective manifold of one of the groups of inflatable cells, each valve selectively controlling the flow of pressurized air from the air source to the respective manifold to provide a therapeutic treatment to a person supported on the patient support apparatus.

12. The patient support apparatus of claim 11, further comprising a controller having a processor and a memory device, the memory device including instructions that when executed by the processor, cause the controller to vary the operation of the air source to change the flow of pressurized air from the air source.

13. The patient support apparatus of claim 12, the memory device including instructions that when executed by the processor, cause the controller to alternately close one of the plurality of valves to thereby stop the flow of air to the group of air cells coupled to the valve that is closed, the air cells deflating due to the exhaust in the air cells.

14. The patient support apparatus of claim 13, the memory device including instructions that when executed by the processor, cause the controller to alternately open the closed valve and to close a different one of the plurality of valves to thereby stop the flow of air to the group of air cells coupled to the valve that is closed and the pressure in the air cells is lowered due to the air exiting the exhaust in the air cells; the previously deflated air cells thereby being inflated.

15. The patient support apparatus of claim 12, the memory device including instructions that when executed by the processor, cause the controller to alternately and intermittently close and open the plurality of valves to thereby stop the flow of air to the group of air cells coupled to the valve that is closed and the pressure in the air cells is lowered due to the air exiting the exhaust in the air cells, and inflate any previously deflated air cells to provide alternating low pressure therapy to a patient supported on the patient support apparatus.

16. The patient support apparatus of claim 15, the memory device including instructions that when executed by the processor, cause the controller to vary the operation of the air source to change the volume of the flow of pressurized air from the air source to compensate for the respective state of the plurality of valves to maintain a predetermined level of inflation in the air cells receiving the flow of air.

17. The patient support apparatus of claim 11, further comprising a controller having a processor and a memory device, the memory device including instructions that when executed by the processor, cause the controller to vary the operation of the pneumatic system to operate in a first mode where the groups of bladders are inflated to a continuous pressure to provide continuous low pressure therapy to a patient supported on the patient support apparatus and a second mode where the groups of bladders are alternately and intermittently inflated to provide an alternating low pressure therapy to the patient, the pneumatic system being operated to provide a flow of air sufficient to remove moisture from the mattress in both the first and second modes.

18. The patient support apparatus of claim 17, the memory device including instructions that when executed by the processor, cause the controller to vary the operation of the air source to change the volume of the flow of pressurized air from the air source to compensate for the respective state of the plurality of valves to maintain a predetermined level of inflation in the air cells receiving the flow of air.

19. The patient support apparatus of claim 18, the memory device including instructions that when executed by the processor, cause the controller to vary the operation of the air source to change the pressure of the flow of pressurized air from the air source to compensate for the respective state of the plurality of valves to maintain a predetermined level of inflation in the air cells receiving the flow of air.

20. The patient support apparatus of claim 17, the memory device including instructions that when executed by the processor, cause the controller to vary the operation of the air source to change the pressure of the flow of pressurized air from the air source to compensate for the respective state of the plurality of valves to maintain a predetermined level of inflation in the air cells receiving the flow of air.
